(19) United States
(12) Patent Application Publication
(10) Pub. No.: US 2020/0210297 A1
(43) Pub. Date: Jul. 2, 2020

(54) INFORMATION PROCESSING APPARATUS AND METHOD OF CONTROLLING INFORMATION PROCESSING APPARATUS

(71) Applicant: CANON KABUSHIKI KAISHA, Tokyo (JP)

(72) Inventor: Akitomo Fukui, Yokohama-shi (JP)

(21) Appl. No.: 16/717,044

(22) Filed: Dec. 17, 2019

(30) Foreign Application Priority Data
Dec. 28, 2018 (JP) 2018-248143

(51) Int. Cl. G06F 11/20

(52) U.S. Cl. CPC G06F 11/2094; G06F 2201/85

(57) ABSTRACT

A main controller of an information processing apparatus includes a central processing unit (CPU), and the CPU includes a hard disk drive (HDD) control unit that performs write and read of data on an HDD, and controls the HDD control unit to control write and read on the HDD. In a case where the CPU detects that an error has occurred that write or read of data on the HDD cannot be performed by the HDD control unit, the CPU performs a recovery process that restores an error with respect to an area where the error has occurred.

### BACKGROUND OF THE INVENTION

### Field of the Invention

The present disclosure relates to a control technology for a hard disk drive (HDD).

### Description of the Related Art

An HDD is a magnetic storage device, and is installed on various information processing apparatuses (e.g., a personal computer (PC), a server, and an image forming apparatus). For example, in an image forming apparatus, in printing job processing, the HDD is used as a storage destination for image data, logs of an apparatus, or the like.

In recent years, in a general information processing apparatus, as a countermeasure against loss of storage information due to sudden failure of the HDD, reaching lifetime, or the like, there is a technology of removing a temporal error by executing recovery write processing, e.g., a dust removing operation for a head or a change in a floating amount of a head. For example, Japanese Patent Application Laid-Open No. 9-251728 discusses a method for removing a temporal read error due to dust by removing a protrusion (dust) on a head or disk by changing the floating amount of the head.

### SUMMARY OF THE INVENTION

An information processing apparatus of the present disclosure includes a storage unit configured to write and read data with respect to a storage medium, and a control unit configured to control the storage unit, wherein, in a case where the control unit detects that an error has occurred such that the storage unit cannot write or read data on the storage medium, the control unit performs a recovery process that restores an error with respect to an area where the error has occurred.

Further features of the present disclosure will become apparent from the following description of exemplary embodiments with reference to the attached drawings.

### BRIEF DESCRIPTION OF THE DRAWINGS

FIG. 1 is a block diagram illustrating an overview configuration of an image forming apparatus of an exemplary embodiment of the present disclosure.

FIG. 2 is a block diagram illustrating an overview configuration of a main controller according to an embodiment of the present disclosure.

FIG. 3 is a view illustrating an overview configuration of a hard disk drive (HDD) according to an embodiment of the present disclosure.

FIG. 4 is a flowchart of HDD control according to a first exemplary embodiment of the present disclosure.

FIG. 5 is a view illustrating an example of a pending sector and an alternative sector on a magnetic disk of the HDD according to an embodiment of the present disclosure.

FIG. 6 is a flowchart of HDD control according to a second exemplary embodiment of the present disclosure.

### DESCRIPTION OF THE EMBODIMENTS

Exemplary embodiments of the present disclosure are described in detail below based on the accompanying drawings. A configuration illustrated in the exemplary embodiments below is a mere example, and the present disclosure is not limited to the illustrated configuration.

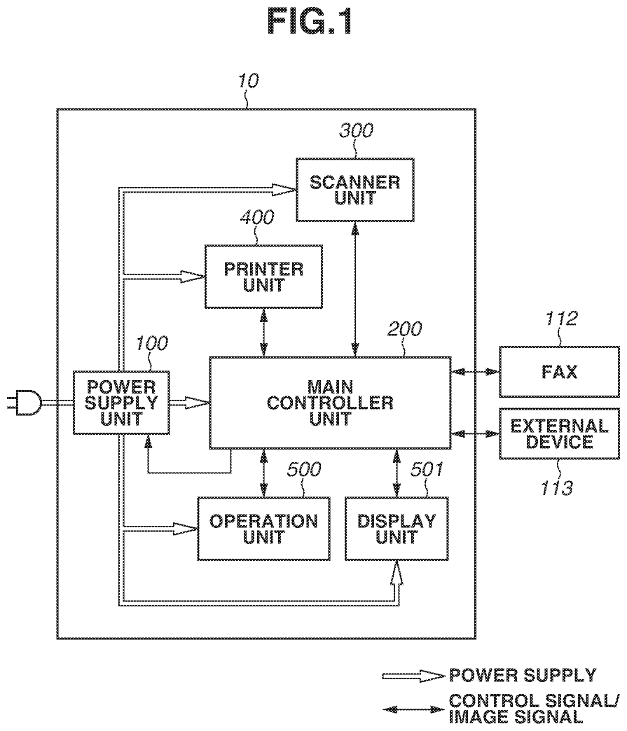

FIG. 1 is a block diagram illustrating an overview configuration of an image forming apparatus 10 as an application example of an information processing apparatus of a first exemplary embodiment.

The image forming apparatus 10 is a multifunction peripheral (MFP) including a plurality of functions, such as a printing function, a scanning function, a copy function, and a facsimile (FAX) function.

The image forming apparatus 10 includes a power supply unit 100, a main controller unit 200, a scanner unit 300, a printer unit 400, an operation unit 500, and a display unit 501.

The power supply unit 100 supplies power to each unit of the image forming apparatus 10. The scanner unit 300 optically reads an image from an original document and generates image data. The printer unit 400 forms an image on a recording medium (paper) using an electrophotographic method. The main controller unit 200 processes image data input from the scanner unit 300, a FAX 112, or an external apparatus 113 to perform processing on image data to be output to the printer unit 400. Moreover, the main controller unit 200 controls a collective operation of the image forming apparatus 10 including the scanner unit 300 and the printer unit 400 based on a user instruction input to the operation unit 500. The display unit 501 displays various statuses (e.g., conditions and settings of copying, error display at the time of occurrence of an error) of the image forming apparatus.

The image forming apparatus 10 executes a copying or scanning operation, and has three types of operation modes: a job mode, a standby mode, and a sleep mode. The job mode is a mode in which all units of the image forming apparatus 10 are energized. The standby mode is a mode in which units other than the scanner unit 300 and the printer unit 400 are energized while waiting for a job. The sleep mode is a mode in which an operation is not conducted except a minimally required load (a communication unit with respect to the outside, such as the FAX 112, or the main controller unit 200).

When receiving a job from the operation unit 500 or the external apparatus 113, such as a personal computer (PC), the image forming apparatus 10 goes into the job mode, and performs an image forming operation. When the job ends, the image forming apparatus 10 transitions into the standby mode. After transitioning into the standby mode and the apparatus is not used even after an elapse of certain period of time or when an operation is performed on the operation unit 500 into the sleep mode, the image forming apparatus 10 transitions into the sleep mode.

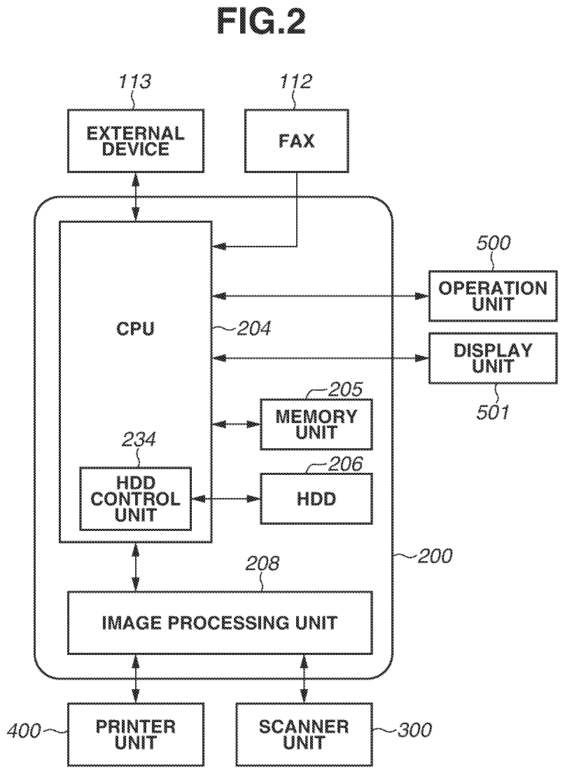

FIG. 2 is a block diagram illustrating a configuration of the main controller unit 200. FIG. 2 also illustrates a peripheral configuration that, for example, exchanges information with respect to the main controller unit 200.

The main controller unit 200 includes a central processing unit (CPU) 204, a memory unit 205, a hard disk drive (HDD) 206, and an image processing unit 208. The CPU 204 is a central processing unit that controls the entire image forming apparatus 10. The CPU 204 receives a signal from the operation unit 500, the FAX 112, or the external apparatus 113, and achieves a function, such as a copy function, a print function, or a FAX function. Moreover, the CPU 204 includes an HDD control unit 234, which controls the HDD 206. The control is described in detail below.

The memory unit 205 is a volatile memory, such as a double data rate synchronous dynamic random access memory (DDR SDRAM), which is a storage unit that temporarily stores data or the like used for a job executed by the CPU 204. The HDD control unit 234 writes or reads data to or from the HDD 206 based on an instruction from the CPU 204.

The HDD 206 is a magnetic storage device, which is a storage device that writes or reads data to or from a magnetic disk, which is a nonvolatile storage medium. The HDD 206 can be configured to be present outside of the image forming apparatus 10. Moreover, although FIG. 2 illustrates an example in which the CPU 204 and the HDD 206 are directly connected, the HDD 206 can be configured such that control is performed using a disk array (not illustrated) different from the CPU 204 depending on the relationship of the capacity of the CPU 204.

The image processing unit 208 is connected to the CPU 204, the printer unit 400, and the scanner unit 300. The image processing unit 208 performs image processing, such as color space conversion, on a digital image sent from the scanner unit 300, and outputs the image processed data to the CPU 204. Moreover, the image processing unit 208 performs image processing, such as color space conversion, based on the image data read by the scanner unit 300, converts the data to bitmap data, and outputs the bitmap data to the printer unit 400.

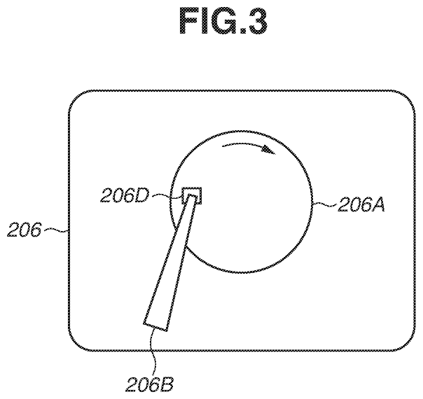

FIG. 3 is an overview block diagram of the HDD 206.

The HDD 206 moves a magnetic head 206B to a sector 206D over a magnetic disk 206A, and performs read and write of data, and data deletion. In the HDD 206, an error may occur, if the sector 206D that performs read and write is shifted due to vibrations from the outside or to temperature and humidity environments or if read and write onto the sector 206D cannot be normally completed due to unexpected shutdown during read and write or influences of dust, grease, or the like. When the CPU 204 detects an error area of the HDD 206 in which read or write cannot be performed, the HDD control unit 234 performs a recovery process that restores the error.

Specifically, the CPU 204 treats a target sector, which is detected as an error area, as a pending sector, and the HDD control unit 234 executes recovery write to the pending sector. Then, the CPU 204 checks the presence/absence of an error regarding the pending sector for which the recovery write has been executed. The CPU 204 determines that the recovery process has succeeded in a case where no error has occurred by the recovery write, and uses the pending sector as a normal sector as it is. Meanwhile, the CPU 204 determines that the recovery process has failed in a case where an error has occurred, and allocates an alternative sector as an alternative area. At this time, if no alternative sector is allocated, the CPU 204 displays on the display unit 501 that HDD failure has occurred.

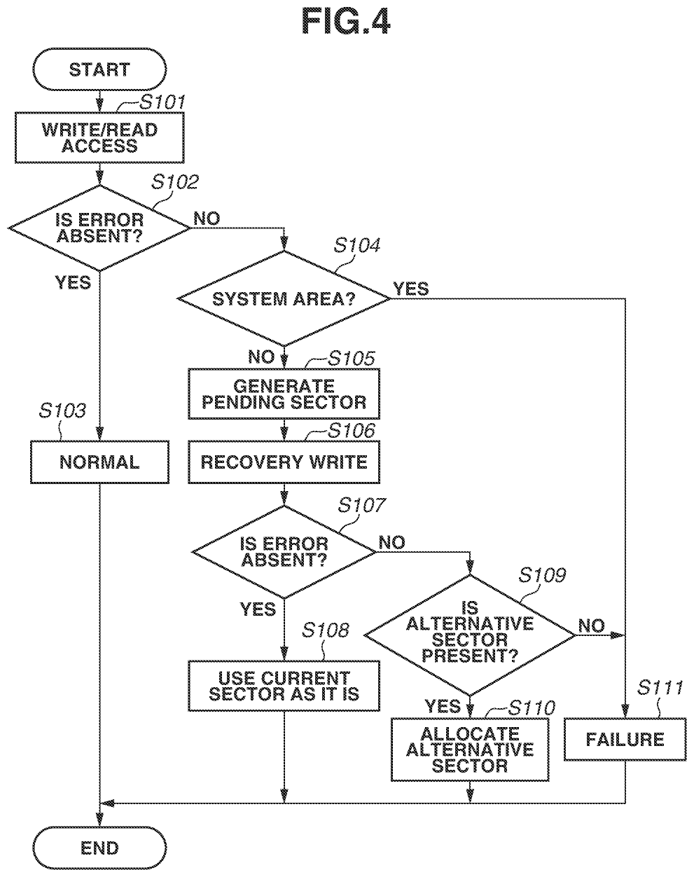

FIG. 4 is a flowchart illustrating a flow of control processing from an HDD access to error handling in the CPU 204 of the first exemplary embodiment. Execution of read and write on the HDD is performed by the HDD control unit 234 in the CPU 204, but this is not described below for the sake of simplicity.

When the HDD 206 is accessed, the processing proceeds to step S101. In step S101, when the access is “write”, CPU 204 executes write processing, while when the access is “read”, CPU 204 executes read processing.

In step S102, the CPU 204 performs determination processing for checking that an error is absent. In a case where the CPU 204 determines that an error is absent in step S102 (YES in step S102), the processing proceeds to step S103. In step S103, the CPU 204 recognizes that the accessed sector is normal, and ends the processing.

In a case where the CPU 204 determines that an error is not absent in step S102 (NO in step S102), the proceeding proceeds to step S104, and the CPU 204 checks whether the sector where the error has occurred (error sector) is a system area. In a case where the CPU 204 determines that the error sector is a system area in step S104 (YES in step S104), the processing proceeds to step S111 because data cannot be restored. The CPU 204 determines that it is failure, displays an HDD exchange request on the display unit 501, and ends the processing. Moreover, also in a case where a particular application stores dedicated data in the HDD, some data cannot be restored as well as in the system area. Accordingly, in step S104, the CPU 204 even determines whether the error sector is dedicated data of the particular application in addition to the system area. Then, in a case where it is determined that the error sector is dedicated data of the particular application, the processing proceeds to step S111. The CPU 204 determines that it is failure, displays an HDD exchange request on the display unit 501, and ends the processing.

In a case where it is determined that the error sector is neither a system area nor an area where the dedicated data of the particular application is stored in step S104 (NO in step S104), the processing proceeds to step S105. In step S105, the CPU 204 treats the currently accessing sector as a pending sector.

The processing proceeds to step S106, and, in step S106, the CPU 204 performs recovery write with respect to the HDD 206.

The processing proceeds to step S107, and, in step S107, the CPU 204 performs determination processing to check that an error is absent in the pending sector on which the recovery write has been executed. Then, in a case where the CPU 204 determines that an error is absent (YES in step S107), the processing proceeds to step S108, while in a case where the CPU determines that an error is not absent (NO in step S107), the processing proceeds to step S109.

In step S108, because the CPU 204 checked that the error has been removed through the recovery write, the CPU 204 treats the current sector, which is the pending sector, as a usable normal sector as it is, and ends the processing.

In step S109, because an error remains even after the recovery write, the CPU 204 performs determination processing to check whether there is an alternative sector that can be allocated as an alternative of the pending sector. In a case where the CPU 204 determines that there is an alternative sector that can be allocated (YES in step S109), the processing proceeds to step S110. In step S110, the CPU 204 performs allocation of the alternative sector and ends the processing. Meanwhile, in a case where the CPU 204 determines that an alternative sector that can be allocated has been used up and cannot be newly allocated (NO in step S109), the CPU 204 determines that failure has occurred in step S111, displays an HDD exchange request, and ends the processing.

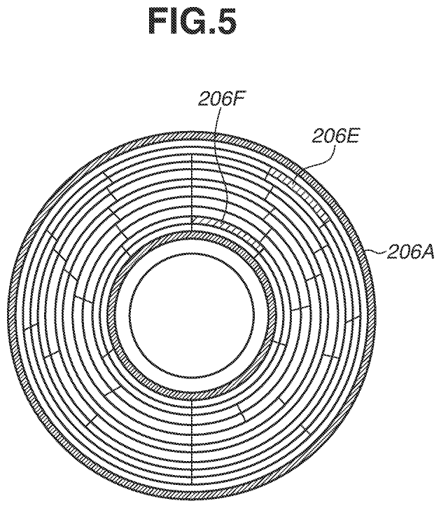

FIG. 5 is a view illustrating a relationship between the pending sector 206E and the alternative sector 206F on the magnetic disk 206A in the HDD 206. FIG. 5 is used to describe a sector management method as below.

The CPU 204 holds a management table for the pending sector and the alternative sector in the memory unit 205. When the target sector, in which the occurrence of an error has been detected, becomes the pending sector, the CPU 204 associates a logical block addressing (LB A) of the pending sector with number information as to the number of times that the sector has become the pending sector (number of pending times), and registers them in the management table. The number information is also registered because, for example, in a case where only LBA is registered, when a physical sector and LBA are replaced in the HDD, such replacement cannot be followed.

The pending sector 206E is generated by the occurrence of an error. Accordingly, when the pending sector is generated by error occurrence, the CPU 204 associates the LBA of the pending sector with information indicative of the number of times that the sector has become the pending sector (number information) and registers them in the management table. For example, when the number of times of becoming the pending sector is the first time, the CPU 204 associates the LBA of the pending sector with the number information indicative of the first time and registers them in the management table.

When the alternative sector 206F has been allocated to the pending sector 206E in step S110, the CPU 204 logically connects the pending sector 206E and the alternative sector 206F. Thus, from the next time, when the LBA of the pending sector 206E is called, an access to the alternative sector 206F, which is logically connected to the pending sector 206E, occurs. The association of the pending sector 206E and the alternative sector 206F is performed on the HDD 206 side.

Moreover, when the sector the LBA of which is the same as the LBA already registered in the management table becomes the pending sector again, the CPU 204 adds one to the number information corresponding to the LBA of the pending sector (adding one to the number of times), and updates the management table based on the number information after the addition.

Meanwhile, for example, when the sector whose LBA is not registered in the management table newly becomes the pending sector, the CPU 204 registers the LBA of the new pending sector and the number information in another registration area of the management table.

The description heretofore takes an example in which, for example, the CPU 204 holds the management table in the memory unit 205, but is not limited thereto. For example, the management table can be held in the HDD control unit 234.

Now, in the present exemplary embodiment, an operation of a case where allocation of an alternative sector is performed, for example, when an HDD read error occurs during a copy operation is described using the aforementioned flowchart of FIG. 4.

The CPU 204 starts a copy job when an original document is set in the scanner unit 300 and input of a copy start button from the operation unit 500 is detected.

When the copy job is started, the CPU 204 causes the scanner unit 300 to read the original document, causes the image processing unit 208 to perform a predetermined image forming process on the read image, and stores the processed data in the HDD 206 via the HDD control unit 234. The storage of the image data in the HDD 206 is performed when the CPU 204 detects a write request to the HDD 206 and executes write processing in step S101 in response to the write request.

Here, it is assumed that an error has not occurred in the write processing. In this case, because no write error has occurred, the processing proceeds from step S102 to step S103, and the CPU 204 recognizes that the accessed sector is normal, and ends the processing.

Moreover, in this example, the job is a copy job, the CPU 204 causes the scanner unit 300 to read as described above and causes the printer unit 400 to print the original document image stored in the HDD 206.

In more detail, the CPU 204 at this time notifies the image processing unit 208 of the original image data stored in the HDD 206 as print processing data. The image processing unit 208 reads the original image data from the HDD 206 and performs image processing for printing with the printer unit 400. That is, when detecting a read request to the HDD 206, the CPU 204 executes read processing in step S101.

Here, it is assumed that an error has occurred in the read processing. In this case, the CPU 204 determines that there is an error in step S102 and checks whether the error sector is a sector in a system area in step S104. Moreover, here, it is assumed that the error sector is not a sector in a system area. In this case, the processing proceeds to step S105, and the CPU 204 treats the error sector as the pending sector. Then, in step S106, the CPU 204 performs recovery write processing on the pending sector having the read error.

At this time, in a case where data remains in the memory unit 205, the CPU 204 uses the data as data for recovery write in step S106. Meanwhile, in a case where data does not remain in the memory unit 205, the CPU 204 uses dummy data and performs recovery write. For a job of the recovery write, a job for re-execution that is executed if a paper jam occurs (a job of a system jam) can be requested to be re-executed, and the data for re-execution can be used for the recovery write. Here, it is assumed that recovery write using dummy data has been performed.

Then, in step S107, the CPU 204 checks whether there is an error as a result of the recovery write. In a case where the CPU 204 determines that there is no error in step S107, the processing proceeds to step S108, and the CPU 204 returns the current sector (pending sector) to the normal sector and ends the processing.

It is sufficient if the dummy data used for the recovery write is data that is understood to be dummy data. The dummy data can be brief data, e.g., ff00ee11 . . . in hexadecimal notation. The size of the dummy data can be 512 bytes to match the sector size. Furthermore, in the case of multiples of 512, it is sufficient if dummy data is prepared for the number of continuous sectors in a case of an error in continuous sectors. Here, for example, it is assumed that an error has occurred in one sector, and therefore the size of the dummy data is 512 bytes. For the dummy data, for example, data described below can be used.

1st byte: 0xff00
2nd byte: 0xee11
. . .
16th byte: 0xfe01
17th byte: 00xed12
. . .
512th byte: 0x00ff

In a case where writing, reading, and verifying of such dummy data are all normal, the CPU 204 determines that the recovery write has succeeded, and the current pending sector 206E is returned to the normal sector and the LBA is used as it is. Meanwhile, in a case where an error is detected in any of writing, reading, and verifying of the dummy data, the CPU 204 determines that the recovery write has failed and allocates the alternative sector 206F with respect to the pending sector 206E.

As described heretofore, in the present exemplary embodiment, if a temporary error due to dust or the like occurs in the HDD, the error sector becomes a pending sector, and the recovery process is performed through the recovery write. Then, in a case where the recovery process using the recovery write succeeds, the pending sector is returned to a normal sector and used as it is. Meanwhile, in a case where the recovery process is failed, an alternative sector is allocated with respect to the pending sector. That is, in the present exemplary embodiment, when a temporary error due to dust or the like can be recovered, service engineer calling is not made so that the HDD can be used continuously. Thus, loads on both the user and the service engineer can be reduced.

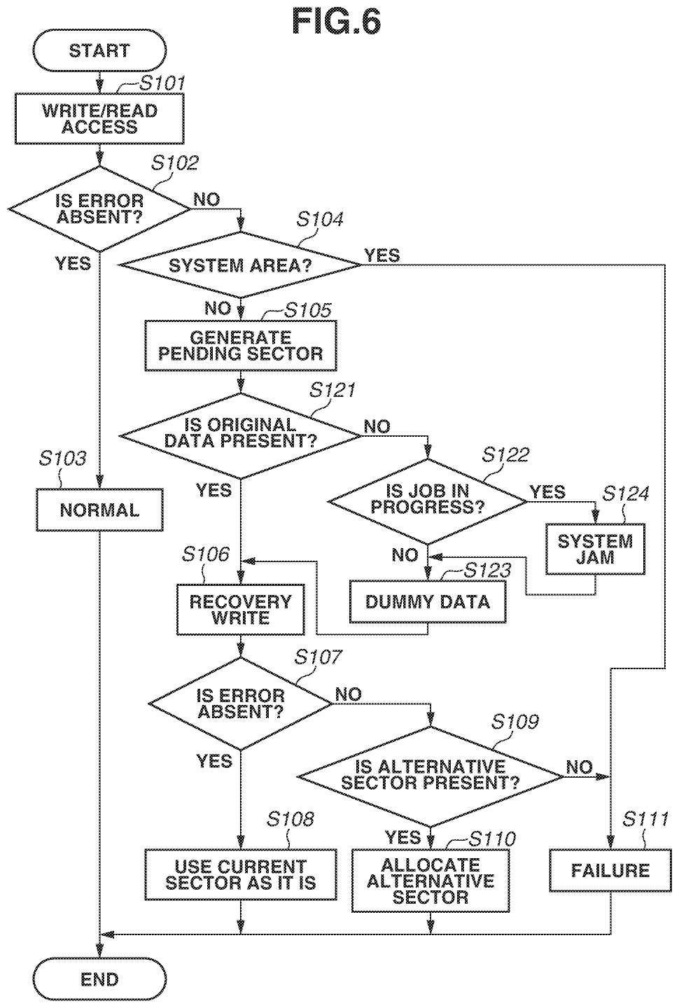

FIG. 6 is a flowchart illustrating a flow of control processing from an HDD access to error processing in the CPU 204 of a second exemplary embodiment. In the flowchart of FIG. 6, the same processing steps as those of the flowchart of FIG. 4 are designated the identical reference numerals as those of FIG. 4, and will not be elaborated. In the flowchart of FIG. 6, processing steps S121 to S124 are added between pending sector generation processing of step S105 and the recovery write processing of step S106. Depending on the presence/absence of original data or whether job execution is in progress, a method for acquiring data for recovery write is changed.

In the flowchart of FIG. 6, after the pending sector is generated in step S105, the CPU 204 performs determination processing of checking the presence/absence of original data in step S121. In a case where the CPU 204 determines that there is original data (YES in step S121), the CPU 204 treats the original data as data for recovery write, and the processing proceeds to step S106. Meanwhile, in a case where the CPU 204 determines that there is no original data (NO in step S121), the processing proceeds to step S122.

When the processing proceeds to step S122, the CPU 204 performs determination processing of checking whether job execution is in progress. Then, in a case where the CPU 204 determines that the job execution is in progress (YES in step S122), the processing proceeds to step S124. The CPU 204 notifies the job process of a job for re-execution (e.g., a system jam) and causes the job processing to start again so that data acquisition can be performed again. After step S124, the CPU 204 causes the processing to proceed to step S123.

In a case where the CPU 204 determines that the job execution is not in progress in step S122 (NO in step S122) or notifies the job process of a job for re-execution in step S124, the processing proceeds to step S123. In step S123, the CPU 204 treats the recovery write data as dummy data. After step S123, in the CPU 204, the processing proceeds to step S106.

Accordingly, in the case of the second exemplary embodiment, in step S106, the CPU 204 executes the recovery write using the original data of step S121 or the dummy data prepared in step S123.

As described heretofore, in the second exemplary embodiment, a job is re-executed with respect to a read error during job execution, and pending sector processing is performed through the recovery write using dummy data. That is, according to the second exemplary embodiment, the recovery process of an HDD can be performed while a job re-execution operation is performed, thereby minimizing the time for a recovery occupation and enabling suppression of excessive HDD exchange.

The exemplary embodiments of the present disclosure have been described in detail heretofore. However, the present disclosure is not limited to the exemplary embodiments, but covers various forms of the scope not departing from the gist of the present disclosure. The functions of the exemplary embodiments and the processing of the flowcharts described above may be achieved solely by a hardware configuration, or may be achieved by a software configuration obtained when a CPU or the like executes a program. Moreover, they may be achieved partly by a hardware configuration and the rest may be achieved by a software configuration. A program for the software configuration may be prepared in advance, or may be acquired from a storage medium, e.g., an external memory, which is not illustrated, or may be acquired via a network or the like, which is not illustrated.

The aforementioned exemplary embodiments merely indicate specific examples of carrying out the present disclosure, and should not restrict the interpretation of the technical scope of the present disclosure. That is, the present disclosure can be carried out in various forms without departing from the technical idea or the main features.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2018-248143, filed Dec. 28, 2018, which is hereby incorporated by reference herein in its entirety.

What is claimed is:

1. An information processing apparatus comprising:
a storage unit configured to write and read data with respect to a storage medium; and
a control unit configured to control the storage unit,
wherein, in a case where the control unit detects that an error has occurred such that the storage unit cannot write or read data on the storage medium, the control unit performs a recovery process that restores an error with respect to an area where the error has occurred.

2. The information processing apparatus according to claim 1, wherein the control unit uses an area where the error has occurred as it is in a case where the recovery process succeeds with respect to the area where the error has occurred, and allocates an alternative area in a case where the recovery process does not succeed.

3. The information processing apparatus according to claim 2, wherein, in a case where there is no area that can be allocated as the alternative area, the control unit causes a display device to display a request for exchanging the storage medium.

4. The information processing apparatus according to claim 2, wherein, in a case where allocation of the alternative area is performed, the control unit logically connects the area where the error has occurred and the alternative area.

5. The information processing apparatus according to claim 1, wherein the control unit manages the number of times that an error processing is set to be pending for performing the recovery process with respect to the area where the error has occurred.

6. The information processing apparatus according to claim 1, wherein the control unit performs the recovery process in a case where the area where the error has occurred is an area that is not a system area provided in the storage medium.

7. The information processing apparatus according to claim 1, wherein the control unit performs the recovery process in a case where the area where the error has occurred is an area that is not an area where data of a particular application is stored.

8. The information processing apparatus according to claim 1, wherein, in a case where data handled in a job regarding the area where the error has occurred remains, the control unit treats the data as data used in the recovery process, and, in a case where data handled in a job regarding the area where the error has occurred does not remain, the control unit treats dummy data as data used in the recovery process.

9. The information processing apparatus according to claim 1, wherein, in a case where data to be used in the recovery process is absent, the control unit performs re-acquisition of data through a job for re-execution with respect to the job when job execution is in progress, and acquires dummy data when job execution is not in progress to treat the dummy data as data used in the recovery process.

10. A method for controlling an information processing apparatus, the method comprising:
storing to write and read data with respect to a storage medium; and
controlling the storing,
wherein, in a case where the controlling detects that an error has occurred such that the storing cannot write or read data on the storage medium, the controlling performs a recovery process that restores an error with respect to an area where the error has occurred.
